(19) United States
(12) Patent Application Publication
(10) Pub. No.: US 2026/0277954 A1
(43) Pub. Date: Sep. 17, 2026

(54) SIGNAL PROCESSING DEVICE, SIGNAL PROCESSING METHOD, AND NON-TRANSITORY COMPUTER-READABLE STORAGE MEDIUM STORING A PROGRAM

(71) Applicant: Kabushiki Kaisha Toshiba, Kawasaki-shi (JP)

(72) Inventor: Daiki TANAKA, Yokohama (JP)

(73) Assignee: Kabushiki Kaisha Toshiba, Kawasaki-shi (JP)

(21) Appl. No.: 19/530,651

(22) Filed: Feb. 5, 2026

(30) Foreign Application Priority Data
Mar. 12, 2025 (JP) 2025-039301

(51) Int. Cl. G06F 16/3329; G06F 18/2113; G06V 20/40; G06F 123/02

(52) U.S. Cl. CPC G06F 16/33295; G06F 18/2113; G06V 20/44; G06F 2123/02

(57) ABSTRACT

According to one embodiment, a signal processing device according to the present invention includes a signal acquisition unit, a detection unit, and a first AQA processing unit. The signal acquisition unit acquires a time-series signal, the detection unit detects a signal of an interval including an event indicated by an event label from the time-series signal as an event signal, and the first AQA processing unit generates an answer sentence to a question sentence on the basis of the time-series signal, interval information indicating a relationship between the time-series signal and the event signal, the event label, and the question sentence related to the event label.

### CROSS-REFERENCE TO RELATED APPLICATION(S)

This application is based upon and claims the benefit of priority from Japanese Patent Application No. 2025-039301, filed Mar. 12, 2025, the entire contents of which are incorporated herein by reference.

### FIELD

Embodiments of the present invention relate to a signal processing device, a signal processing method, and a non-transitory computer-readable storage medium storing a program.

### BACKGROUND

Audio Question Answering (AQA) is a technique for outputting an answer to an instruction or a question sentence when the instruction or the question sentence related to time-series information such as audio is given. In a case where the existing AQA is used, there is a problem that it is difficult to obtain an appropriate answer sentence for a scene or an event because an appropriate question sentence according to the type of the time-series signal cannot be selected.

### BRIEF DESCRIPTION OF THE DRAWINGS

FIG. 1 is a block diagram illustrating an example of a configuration of a signal processing system 1 according to a first embodiment.

FIG. 2 is a schematic diagram illustrating an example of the external appearance of the measuring device 10 according to the first embodiment.

FIG. 3 is a block diagram illustrating an example of a functional configuration of a signal processing device 20 according to the first embodiment.

FIG. 4 is a schematic diagram illustrating an example of the functional configuration of a detection unit 25.

FIG. 5 is a schematic diagram illustrating input and output of the first AQA processing unit 27 in the first embodiment.

FIG. 6 is a schematic diagram illustrating an example of the processing configuration of the first AQA processing unit 27.

FIG. 7 is a schematic diagram illustrating an example of an output screen as the answer output unit 28.

FIG. 8 is a schematic diagram illustrating a method of selecting and displaying an event signal in the answer output unit 28.

FIG. 9 is a schematic diagram illustrating an example of a case where a check box 521 of the answer output unit 28 is operated.

FIG. 10 is a block diagram illustrating an example of a functional configuration of a signal processing device 20 according to a second embodiment.

FIG. 11 is a schematic diagram illustrating an example of input / output of the question generation unit 210 in the second embodiment.

FIG. 12 is a block diagram illustrating an example of a functional configuration of a signal processing device 20 according to the third embodiment.

FIG. 13 is a block diagram illustrating an example of a functional configuration of a signal processing device 20 according to a fourth embodiment.

FIG. 14 is a diagram illustrating an example of the processing configuration of a signal separation unit 300.

FIG. 15 is a block diagram illustrating an example of a functional configuration of a signal processing device 20 according to a fifth embodiment.

FIG. 16 is a schematic diagram illustrating a detection display unit 400.

FIG. 17 is a schematic diagram illustrating a question signal display portion 410.

FIG. 18 is a schematic diagram illustrating a question registration unit 420.

FIG. 19 is a block diagram illustrating an example of a functional configuration of a signal processing device 20 according to a sixth embodiment.

FIG. 20 is a block diagram illustrating an example of a functional configuration of a scene generation unit 500.

FIG. 21 is a diagram illustrating an example of a processing procedure of the scene generation unit 500.

FIG. 22 is a schematic diagram illustrating an example of an output screen of the image / video output unit 513.

FIG. 23 is a schematic diagram illustrating an image / video display screen 570.

FIG. 24 is an example of an external appearance of a wearable device 600 according to a seventh embodiment.

FIG. 25 is a block diagram illustrating a configuration example of a wearable device 600 according to the seventh embodiment.

FIG. 26 is an example of an external appearance of a wearable device 600 according to a eighth embodiment.

FIG. 27 is a block diagram illustrating a configuration of a wearable device 600 according to the eighth embodiment.

### DETAILED DESCRIPTION

In general, according to one embodiment, a signal processing device according to the present invention includes a signal acquisition unit, a detection unit, and a first AQA processing unit. The signal acquisition unit acquires a time-series signal, the detection unit detects a signal of an interval including an event indicated by an event label from the time-series signal as an event signal, and the first AQA processing unit generates an answer sentence to a question sentence on the basis of the time-series signal, interval information indicating a relationship between the time-series signal and the event signal, the event label, and the question sentence related to the event label.

Hereinafter, the present embodiment will be described in detail with reference to the drawings.

### First Embodiment

In the present embodiment, a scene in which the time-series signal processed by the signal processing device 20 is an audio signal and is utilized in a platform of a railway station or the like will be described as an example. However, the time-series signal that can be processed by the signal processing device 20 is not limited to the audio signal, and a time-series signal obtained from a heart rate or an acceleration sensor described in the following embodiment, or other time-series signals can also be processed.

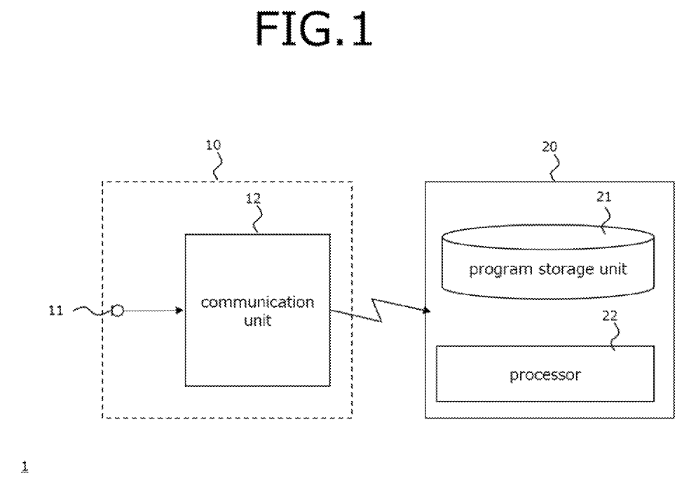

FIG. 1 is a block diagram illustrating an example of a configuration of a signal processing system 1 according to the present embodiment. As shown in FIG. 1, the signal processing system 1 includes a measuring device 10 and a signal processing device 20.

The measuring device 10 includes a sensor 11 and a communication unit 12.

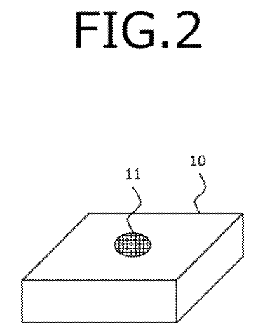

FIG. 2 is a schematic diagram illustrating an example of the external appearance of the measuring device 10 according to the present embodiment.

The sensor 11 measures data to be processed and converts the data into an analog signal. As shown in the present embodiment, when the signal processing device 20 performs processing on a sound signal, the sensor 11 is a microphone, and measures an audio signal including a voice and an environmental sound and converts the audio signal into an analog signal. The analog signal is input to the communication unit 12 via a wired or wireless connection.

Referring back to FIG. 1, the description will be continued. The communication unit 12 converts an analog signal into a digital signal and transmits the digital signal to the signal processing device 20 in a wired or wireless manner.

The signal processing device 20 includes a program storage unit 21 and each processor 22. The signal processing device 20 receives the time-series signal transmitted from the communication unit 12 and performs a predetermined operation.

The program storage unit 21 is, for example, a semiconductor memory element such as a random access memory (RAM) or a flash memory, a hard disk, an optical disk, or the like. The label storage unit 24 may be a storage device that is provided outside the signal processing device 20 and is capable of communicating with the signal processing device 20 via a wired or wireless network. The program storage unit 21 stores various programs to be executed by the various processors 22.

The various processors 22 control the operation of the signal processing device 20. The various processors 22 operate as a signal acquisition unit 23, a detection unit 25, a first AQA processing unit 27, and the like by executing the program stored in the program storage unit 21.

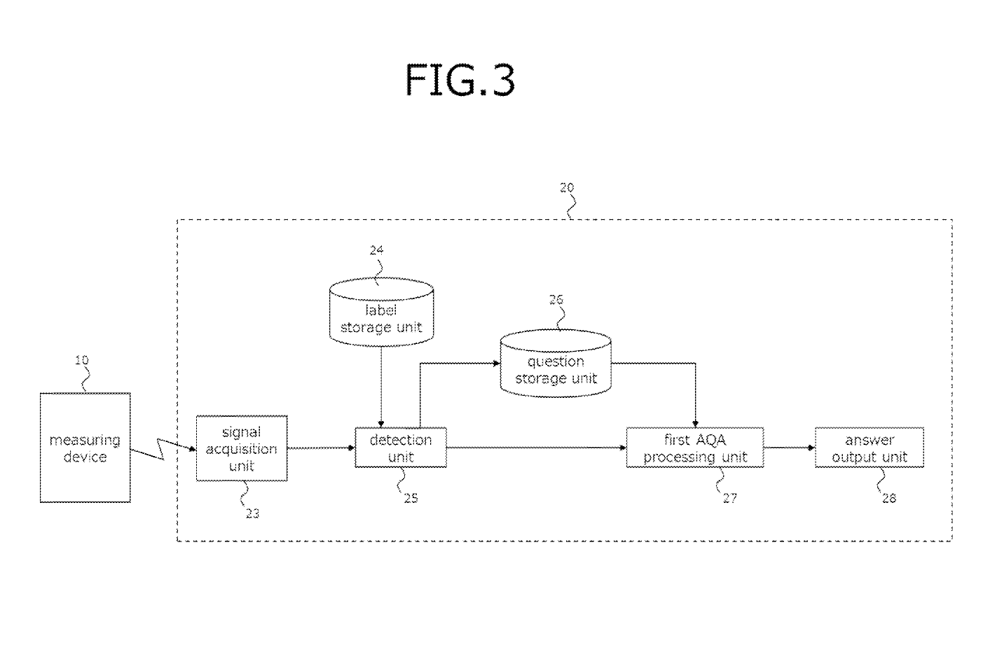

FIG. 3 is a block diagram illustrating an example of a functional configuration of the signal processing device 20 according to the present embodiment. The signal processing device 20 includes a signal acquisition unit 23, a label storage unit 24, a detection unit 25, a question storage unit 26, a first audio question answering (AQA) processing unit 27, and an answer output unit 28.

The signal acquisition unit 23 reads and executes the program stored in the program storage unit 21, thereby acquiring the time-series signal converted by the communication unit 12. The time-series signal is supplied to the detection unit 25.

The label storage unit 24 stores an event label 30. The event label 30 is a category label indicating the content of the time-series signal. For example, the event information may be registered in the form of a single-label text such as "train", a multi-label text including two or more events such as "train and impact sound", a text representing an event change such as "train → impact sound", or a free-description text. The event label 30 is not limited to text input, and may be input by voice, image, or the like. The label storage unit 24 is, for example, a semiconductor memory element such as a random access memory (RAM) or a flash memory, a hard disk, an optical disk, or the like. The label storage unit 24 may be a storage device that is provided outside the signal processing device 20 and is capable of communicating with the signal processing device 20 via a wired or wireless network.

The detection unit 25 reads and executes the program stored in the program storage unit 21, thereby detecting, as an event signal, a signal of an interval including an event indicated by the event label 30 registered in advance in the label storage unit 24 from the time-series signal using a machine learning model obtained by modeling a feature of an audio of a specific event (for example, a sound of a train).

For example, when the time-series signal includes a sound of a train, an announcement sound, and other noise, and the event label 30 is "train", the detection unit 25 detects a signal of an interval including the sound of the train from the time-series signal as an event signal. The detection unit 25 outputs the event label 30 to the question storage unit 26, and outputs the time-series signal, the event label 30 corresponding to the event, and the interval information regarding the interval in which the event is detected to the first AQA processing unit 27.

The question storage unit 26 stores a question sentence 31 related to the event label 30. As an example, the question storage unit 26 stores several question lists in which a plurality of question sentences 31 corresponding to the event label 30 are organized in a list format. The question storage unit 26 is, for example, a semiconductor memory element such as a random access memory (RAM) or a flash memory, a hard disk, an optical disk, or the like. The question storage unit 26 may be a storage device provided outside the signal processing device 20. The question storage unit 26 receives information on the event label 30 included in the audio signal from the detection unit 25, selects a question list corresponding to the event label 30 corresponding to the event detected by the detection unit 25, and supplies the question list to the first AQA processing unit 27. In the question list, predefined question sentences are registered. Specifically, the question storage unit 26 stores a plurality of types of question lists corresponding to each event label 30 (for example, "train"), and each question list includes a plurality of question sentences related to the train when the corresponding event label 30 is, for example, "train". The question storage unit 26 may be a storage device that is provided outside the signal processing device 20 and can communicate with the signal processing device 20 via a wired or wireless network. The question sentences 31 stored in the question storage unit 26 are not necessarily organized in a list format, and may be stored individually and independently. However, the following description will be made by taking an embodiment in which a plurality of question sentences 31 are organized in a question list and stored as an example.

The first AQA processing unit 27 reads and executes the program stored in the program storage unit 21, thereby receiving the time-series signal, the interval information indicating the relationship between the time-series signal and the event interval, and the event label 30 from the detection unit 25, receiving the text of the question sentence 31 related to the event label 30 from the question storage unit 26, and generating the answer sentence 32 to the question sentence 31 based on these.

The answer output unit 28 outputs and displays the pair of the answer sentence 32 and the question sentence 31 for each event label 30 generated by the first AQA processing unit 27, the time-series signal acquired by the signal acquisition unit 23, and the event label 30 detected by the detection unit 25. The answer output unit 28 includes a display such as a liquid crystal display or an organic EL display capable of outputting a processing result by the first AQA processing unit 27 as an image. The answer output unit 28 is a touch panel or the like on which a touch operation can be performed. The answer output unit 28 may be provided separately from the signal processing device 20.

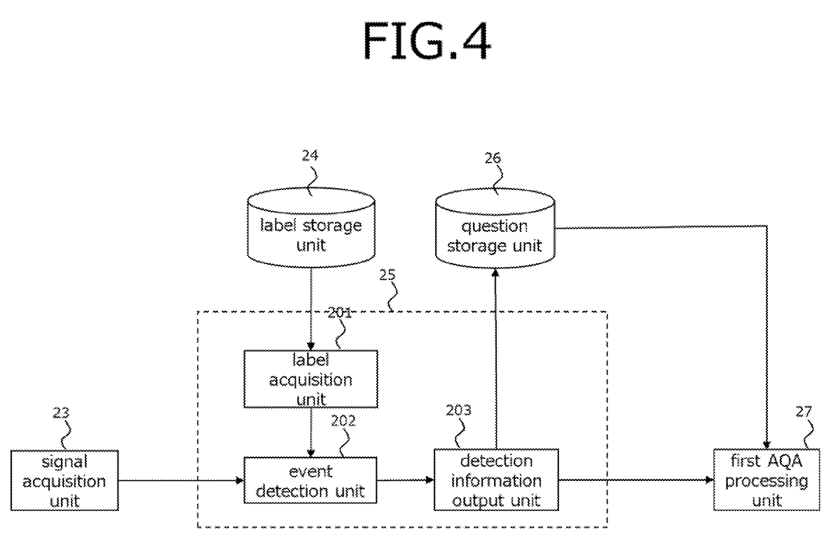

FIG. 4 is a schematic diagram illustrating a functional configuration example of the detection unit 25. As illustrated in FIG. 4, the detection unit 25 includes a label acquisition unit 201, an event detection unit 202, and a detection information output unit 203.

The label acquisition unit 201 acquires the event label 30 corresponding to an event to be detected from the time-series signal from the label storage unit 24, and outputs the acquired event label 30 to the event detection unit 202.

The event detection unit 202 determines whether or not a signal corresponding to an event indicated by the event label 30 is included in the time-series signal using a machine learning model on the basis of the event label 30 input from the label acquisition unit 201, and in a case where it is determined that the signal corresponding to the event is included in the time-series signal, the event detection unit 202 detects a signal in an interval corresponding to the event as an event signal. The event detection unit 202 detects a signal corresponding to a specific event (for example, the sound of a train) from the time-series signal using a machine learning model acquired by modeling the feature of the sound of the event. As the audio feature, various features such as MFCC (Mel Frequency Cepstral Coefficients), a frequency spectrum, a zero crossing rate, and energy may be used. The machine learning model is constructed using a deep neural network (DNN), a support vector machine (SVM), or other appropriate algorithms. Specifically, the detection unit 25 determines whether or not a signal corresponding to an event indicated by the event label 30 is included in the time-series signal acquired by the signal acquisition unit 23, using a machine learning model. If it is determined that the event is included, a signal corresponding to the event is detected. The detected signal is referred to as an event signal.

The detection information output unit 203 outputs the event label 30 corresponding to the event to the question storage unit 26. The detection information output unit 203 outputs the time-series signal, the interval information, and the event label 30 corresponding to the event to the first AQA processing unit 27. The interval information indicating the event interval may be, for example, the start time and the end time of the event interval.

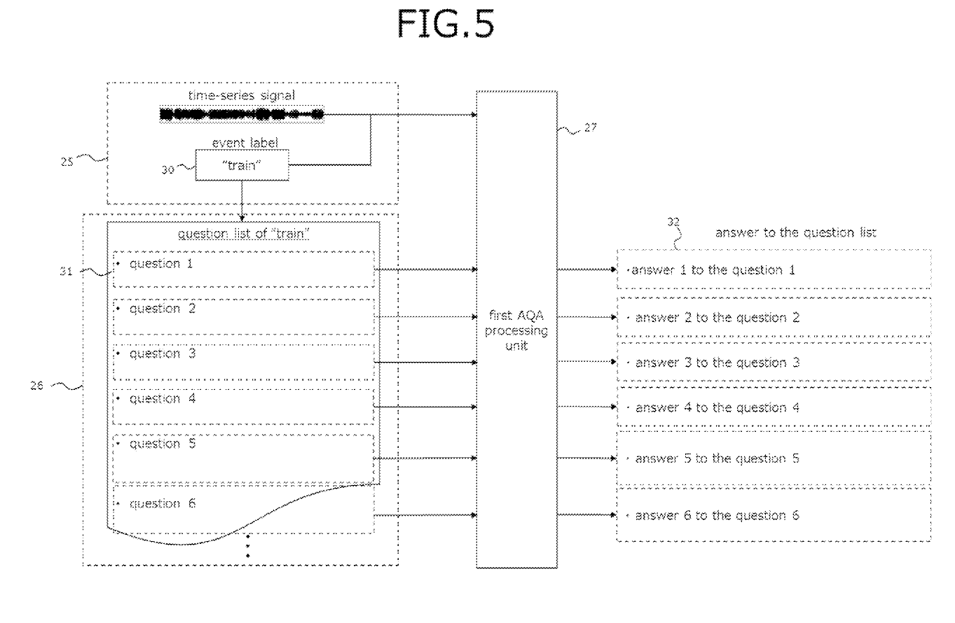

FIG. 5 is a schematic diagram illustrating input and output of the first AQA processing unit 27 in the present embodiment. The first AQA processing unit 27 reads and executes the program stored in the program storage unit 21, thereby executing the AQA processing corresponding to the event label 30. As illustrated in FIG. 5, the first AQA processing unit 27 first acquires the event label 30 and the time-series signal corresponding thereto from the detection unit 25. The question list corresponding to the event label 30 is selected and acquired from the question storage unit 26. An event signal corresponding to the event label 30 and each question sentence 31 in the question list are combined and sequentially input to the first AQA processing unit 27, and the first AQA processing unit 27 generates an answer sentence 32 corresponding to each question sentence 31. The question sentence 31 may be either interrogative, such as "Is it ...?", or imperative, such as "Please tell me about ....". The answer sentence 32 generated by the first AQA processing unit 27 may be in free-form text (for example, "A train is likely to have arrived." or "The Emergency brake may have been activated.") or in a binary format such as "Yes" or "No". The language used for question sentence 31 and answer sentence 32 may be a language other than Japanese, such as English, Chinese, Korean, German, or Spanish, and do not necessarily have to be the same. The selection of the answer format is determined as appropriate according to the question content and the system requirements.

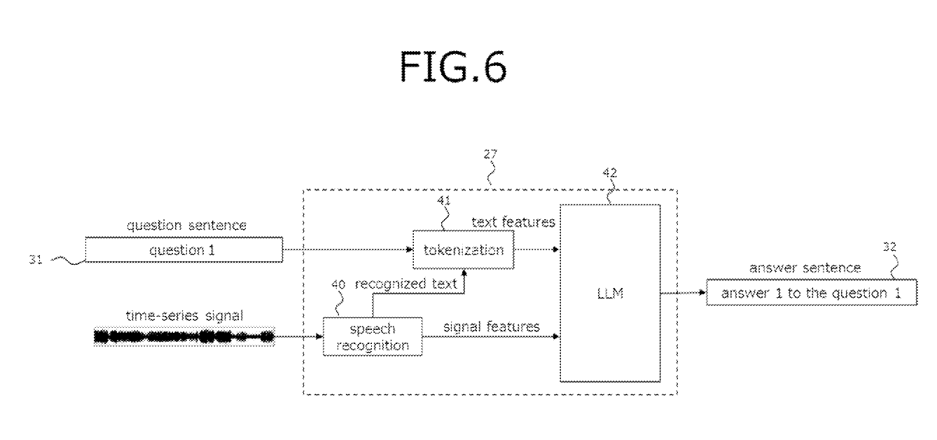

FIG. 6 is a schematic diagram illustrating a processing configuration example of the first AQA processing unit 27. As shown in FIG. 6, the first AQA processing unit 27 includes a speech recognition module 40, a tokenization module 41, and a large language model 42 (hereinafter, "LLM") using a natural language generation technique. The processing configuration of FIG. 6 is an example, and the present embodiment is not limited thereto, and another appropriate algorithm that receives the question sentence 31 and the signal as inputs and outputs the answer sentence 32 may be used.

The time-series signal is input to the speech recognition module 40. The speech recognition module 40 recognizes a speech included in the time-series signal, converts the speech into text, and extracts a feature of the signal (for example, a pitch or intensity of a speech, an emotion of a speaker, or the like). In this specification, the text converted by the speech recognition module 40 is referred to as recognized text. The feature extracted by the speech recognition module 40 is referred to as a signal feature. Recognized text refers to the language information contained within the time-series signal, which is used by the LLM 42 to interpret the language information within the signal. On the other hand, the audio information refers to signal features of the time-series signal (e.g., pitch and intensity of audio, emotion of a speaker, characteristics of environmental sound, etc.), and is used by the LLM 42 to determine a situation in the signal. As the signal feature, various acoustic feature vectors such as MFCC and filter bank feature vectors can be used. In the example shown in FIG. 6, the speech recognition module 40 is used because a case where speech is included as the time-series signal is illustrated, but the present embodiment is not limited thereto. It is only necessary to extract at least a signal feature from a time-series signal using an appropriate algorithm according to a signal to be treated. For example, if the input is a heart rate signal, an algorithm for extracting a signal feature of the heart rate can be used, and if the input is a signal acquired from an acceleration sensor, an algorithm for extracting a signal feature of the acceleration sensor can be used.

The question sentence 31 and the recognized text that is the output of the speech recognition module 40 are input to the tokenization module 41. The tokenization module 41 converts the recognition text obtained by the speech recognition module 40 and the input question sentence 31 into features for input to the LLM 42. The feature converted by the tokenization module 41 is referred to as a text feature.

The signal feature, which is the output of the speech recognition module 40, and the text feature, which is the output of the tokenization module 41, are input to the LLM 42. The LLM 42 receives the signal feature and the text feature and generates an answer sentence 32. Although the LLM 42 is used for the sake of simplicity, the present embodiment is not limited to this, and other appropriate algorithms may be used. At this time, the text feature is converted into a feature according to the algorithm. In this example, the LLM 42 is processed by combining the signal feature and the text feature, but in another example, only the signal feature may be used. In such a case, the LLM 42 operates using at least the signal features. In addition, the LLM 42 uses a model that has been trained to accept signal features in addition to text features. In this example, the LLM 42 has been learned so as to be able to accept the feature of the audio signal, but the LLM 42 learned so as to accept a corresponding signal feature can be used for other signals.

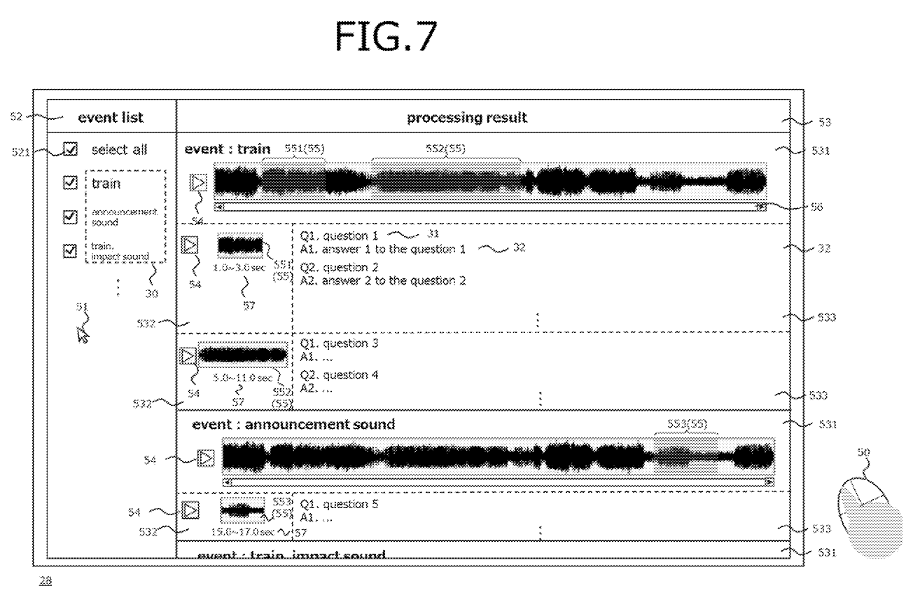

FIG. 7 is a schematic diagram illustrating an example of an output screen as the answer output unit 28. The answer output unit 28 is configured by an event list screen 52 for displaying a list of the event labels 30 for selecting event labels 30, and a processing result screen 53 for displaying a processing result of the time-series signal by the first AQA processing unit 27.

The event list screen 52 displays a plurality of event labels 30 and an option of "select all" for collectively selecting all of the plurality of event labels 30 as a list, and a check box 521 is displayed next to each of the plurality of event labels 30 and "select all". The user can move the cursor 51 in accordance with the operation of the mouse 50 to select the check box 521. The plurality of selected event labels 30 are events to be displayed, and the processing results of the corresponding events are displayed on the processing result screen 53. The operation using the mouse 50 is an example, and where the answer output unit 28 is configured by a touch panel, the user can select a desired option with a finger, a touch pen, or the like without using the mouse 50. In FIG. 7, reference numeral 521 denotes a check box, but the check box is not limited to this, and various display forms can be used. For example, various display forms such as a circle, a cross, and a solid may be used instead of the check box.

The processing result screen 53 is configured by a signal display screen 531, an event signal display screen 532, and a question and answer display screen 533. The signal display screen 531, the event signal display screen 532, and the question and answer display screen 533 exist for each event label 30.

The signal display screen 531 displays the digital time-series signal acquired by the signal acquisition unit 23, and the time-series signal can be reproduced as an audio when the user selects the play button 54. The event signal 55 of the interval including the event indicated by the event label 30 is a signal of the interval corresponding to the event label 30. In the example of FIG. 7, since there are two event signals 55 in the time-series signal of the event label "train", it can be confirmed that (1) the event signal 551 and (2) the event signal 552 are the event intervals corresponding to the event label "train". Further, by using the scroll bar 56, it is possible to move the time-series signal to be treated to the left and right and view the signal in detail.

The event signal display screen 532 displays a play button 54 and an event signal 55 corresponding to the event label 30. The event signal 55 corresponds to the signal represented by the event signal 55 of the signal display screen 531. In addition, interval information (for example, a start time and an end time) indicating an interval in which an event is detected is displayed as a time 57. The display is not limited to the time 57, and other interval information for explaining the interval in which the event is detected may be displayed.

The question / answer display screen 533 displays the question sentence 31 and the answer sentence 32 input to the first AQA processing unit 27 for each event signal. For example, in the case of FIG. 7, the question sentence 31 and the answer sentence 32 for the event signal 551 and the event signal 552 of the event label "train" are displayed on the question and answer display screen 533, respectively. Similarly, when the event label "announcement sound" is set separately, the event signal 553 is displayed on the event signal display screen 532, and the question sentence 31 and the answer sentence 32 for the event signal 553 are displayed on the question / answer display screen 533.

In this example, the event signal 55 is expressed by highlighting, but various types, such as the highlight intensity, color, and signal waveform color, can be used as appropriate. Alternatively, the event signal 55, the event signal 55 of the event signal display screen 532, and the question sentence 31 and the answer sentence 32 of the question and answer display screen 533 may be associated with each other by color.

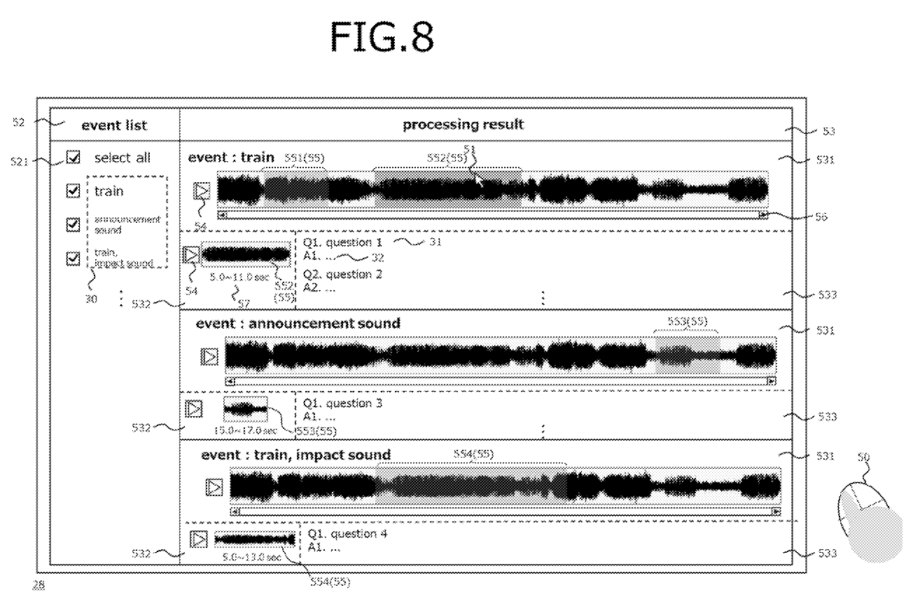

FIG. 8 is a schematic diagram illustrating a method of selecting and displaying an event signal in the answer output unit 28. When the user moves the cursor 51 by operating the mouse 50 or the like to select the event signal 55, the event signal 55 is highlighted, and in conjunction with this, the event signal display screen 532 and the question and answer display screen 533 corresponding to the selected event signal are filtered and displayed. For example, in the case of FIG. 7, when the mouse 50 is operated to move the cursor 51 and select the event signal 55 related to the event signal 552, the event signal display screen 532 and the question and answer display screen 533 corresponding to the event signal 552 are displayed in a filtered manner in conjunction with the selection.

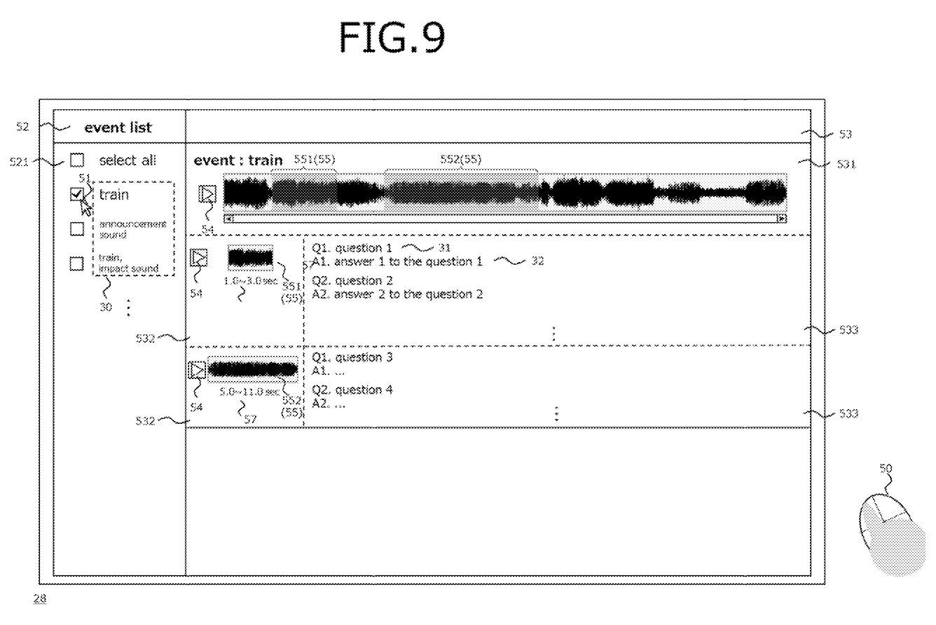

FIG. 9 is a schematic diagram illustrating a case where the check box 521 of the answer output unit 28 is operated. By operating the mouse 50 to move the cursor 51 and select the check box 521, the signal display screen 531, the event signal display screen 532, and the question and answer display screen 533 are filtered and displayed corresponding to the event label 30 selected by the check box 521. In the example of FIG. 9, when the event label "train" is selected in the check box 521, the signal display screen 531, the event signal display screen 532, and the question and answer display screen 533 of the event label "train" are filtered and displayed according to the selection.

Further, the example of FIG. 8 and the example of FIG. 9 can be used in combination. For example, as in the example of FIG. 9, after selecting the event label 30, for example, "train" with the check box 521, by selecting an arbitrary event signal 55 in the signal display screen 531, the event label "train" and the event signal 55 corresponding thereto are filtered to the event signal display screen 532 and the question and answer display screen 533, and can be confirmed more simply.

As described in the present embodiment, the signal processing device 20 equipped with the AQA system capable of dynamically switching the question sentence appropriate for the specific event can be provided by the detection unit 25 detecting the signal interval corresponding to the event label 30 registered in advance from the input time-series signal using the machine learning model obtained by modeling the feature of the audio of the specific event, the question storage unit 26 storing the plurality of question lists selecting the question list corresponding to the event label 30 corresponding to the event detected by the detection unit 25 and supplying the selected question list to the first AQA processing unit 27, and the first AQA processing unit 27 combining the event signal corresponding to the event label 30 and each question sentence 31 in the question list as inputs and generating the answer sentence 32 corresponding to each question sentence 31. Accordingly, the signal processing device 20 can select an appropriate question sentence according to the type of the audio data and generate a question sentence and an answer sentence more appropriate for a scene or an event.

### Second Embodiment

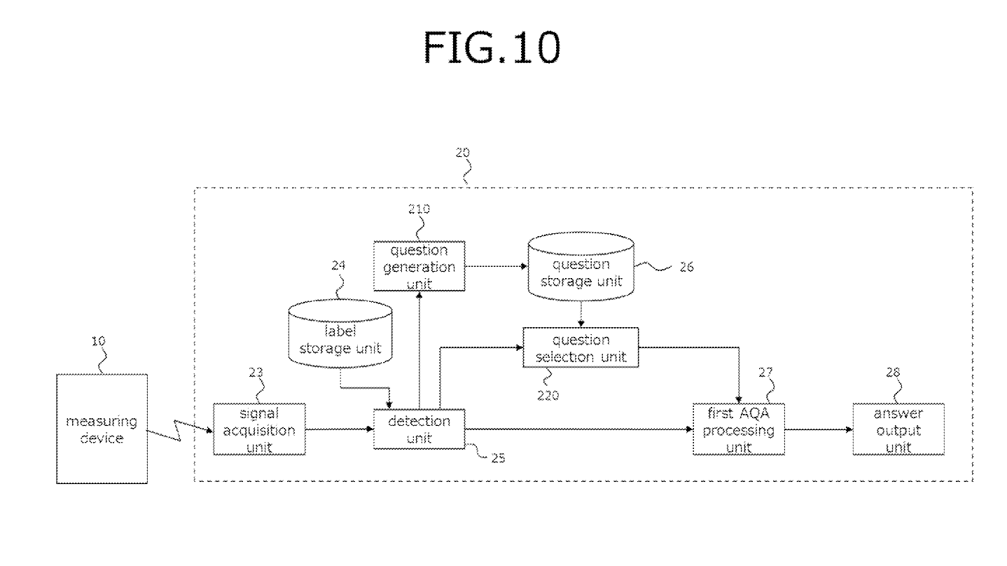

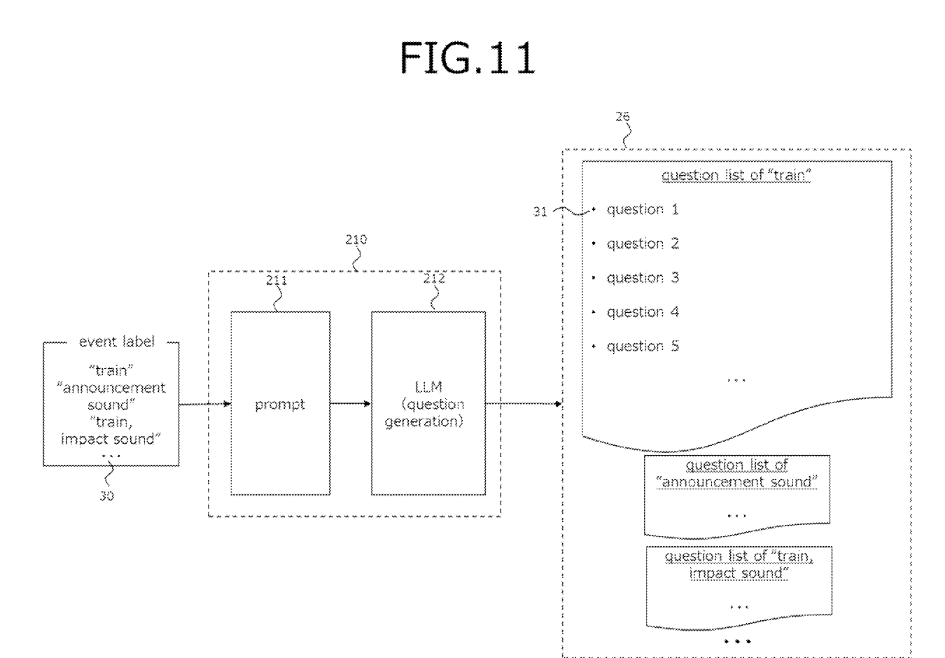

A second embodiment of the present invention will be described with reference to FIGS. 10 and 11. The same reference numerals are given to the same configurations as those of the first embodiment and are used in the description of the present embodiment, and the description of the components that operate in the same manner as the operation in the above embodiment will be omitted.

FIG. 10 is a block diagram illustrating an example of a functional configuration of the signal processing device 20 according to the present embodiment. In the present embodiment, the signal processing device 20 includes a question generation unit 210 and a question selection unit 220 in addition to the signal acquisition unit 23, the label storage unit 24, the detection unit 25, the question storage unit 26, the first AQA processing unit 27, and the answer output unit 28.

The detection unit 25 reads and executes the program stored in the program storage unit 21, thereby detecting, as an event signal, a signal of an interval including an event indicated by the event label 30 registered in advance in the label storage unit 24 from the time-series signal using a machine learning model obtained by modeling a feature of an audio of a specific event (for example, a sound of a train, an announcement sound, or the like).

The detection unit 25 outputs the event label 30 corresponding to the event signal to the question generation unit 210 and the question selection unit 220. Further, the detection unit 25 outputs the time-series signal, the event label 30, and the interval information regarding the event interval to the first AQA processing unit 27.

The question generation unit 210 reads and executes the program stored in the program storage unit 21, thereby automatically generating a question sentence 31G based on the event label 30. The automatically generated question sentences 31G are organized as a question list for each event label 30 and stored in the question storage unit 26.

The question selection unit 220 reads and executes the program stored in the program storage unit 21, thereby selecting the question sentence 31 related to the event label 30 corresponding to the event from the question storage unit 26 that stores the plurality of question sentences 31 and the question sentence 31G. For example, the question selection unit 220 selects a question list including the question sentence 31 or the question sentence 31G related to the event label 30 corresponding to the event. Specifically, the question selection unit 220 outputs the selected question list to the first AQA processing unit 27.

The question generation unit 210 receives a plurality of event labels 30 (for example, "train") and generates a question sentence 31G based on each event label 30. The question sentence 31G may be generated using LLM, but is not limited thereto, and may be generated using other appropriate algorithms. In order to make the following description more specific, LLM is used to generate the question sentence 31G.

FIG. 11 is a schematic diagram illustrating an example of input and output of the question generation unit 210 according to the present embodiment. The question generation unit 210 constructs a prompt 211 for LLM 212 for the received event label 30. For example, when the event label 30 is "train", the prompt 211 is displayed as follows: "The following event is detected from the signal data: "train". Based on this event, generate N question sentences about the train." Here, N is a natural number of 1 or more, and the number of question sentences 31G to be generated can be designated. The generated question sentence 31G is "Is this the sound of a train arriving or departing?", "How strong is the sound of the train's braking, and is there a possibility that the emergency brake is activated?", "From this sound, can you tell whether the train is in motion?", "Is the sound of the train doors opening and closing included? If it is, how many times does the doors open and close?", " Is it possible to determine the specific type of train (e.g., high-speed railway, subway, local train) from this sound? If so, what is the basis for the identification?" and the like. The above-described prompt 211 is an example, and the question sentence 31G can be generated using another prompt 211. For example, different types of prompts 211 or prompts 211 with additional contextual information may be used to increase the accuracy and diversity of question generation. In addition, other languages such as English, Chinese, and Korean may be used.

The question generation unit 210 creates a question list for each event label 30 and registers the generated question sentence 31G in the list. When a question list corresponding to the event label 30 already exists, the newly generated question sentence 31G can be additionally registered in the list. In this way, the question generation unit 210 generates the question sentence 31G and the question list based on the received event label 30, and the generated question list is stored in the question storage unit 26.

The question selection unit 220 receives the event label 30 from the detection unit 25, and searches the question list corresponding to the event label 30 from the question storage unit 26 to select the question list. Specifically, when the event label 30 (for example, "train") is input, the question selection unit 220 confirms whether or not a question list corresponding to the event label 30 is already stored in the question storage unit 26. According to the present embodiment, since the question generation unit 210 generates a question list for each event label 30, a question list corresponding to the event label 30 is necessarily present. The question selection unit 220 selects the corresponding question list and supplies the question list to the first AQA processing unit 27. The first AQA processing unit 27 executes processing corresponding to the question list, and some processing result is displayed on the answer output unit 28.

The first AQA processing unit 27 has the same configuration and function as those of the first embodiment, and thus a detailed description thereof will be omitted. In the present embodiment, the input of the first AQA processing unit 27 is the question sentence 31 or the question list selected in the question selection unit 220 in addition to the time-series signal, the corresponding event label 30, and the interval information. Based on these inputs, the first AQA processing unit 27 generates an answer sentence to the selected question sentence 31 or question sentence 31G.

The answer output unit 28 has the same configuration and function as those of the first embodiment, and thus detailed description thereof will be omitted. In the second embodiment, the question generation unit 210 generates the question sentence 31G, and thus it is possible to perform multifaceted event detection processing based on the event label 30 that the user wants to detect.

### Third Embodiment

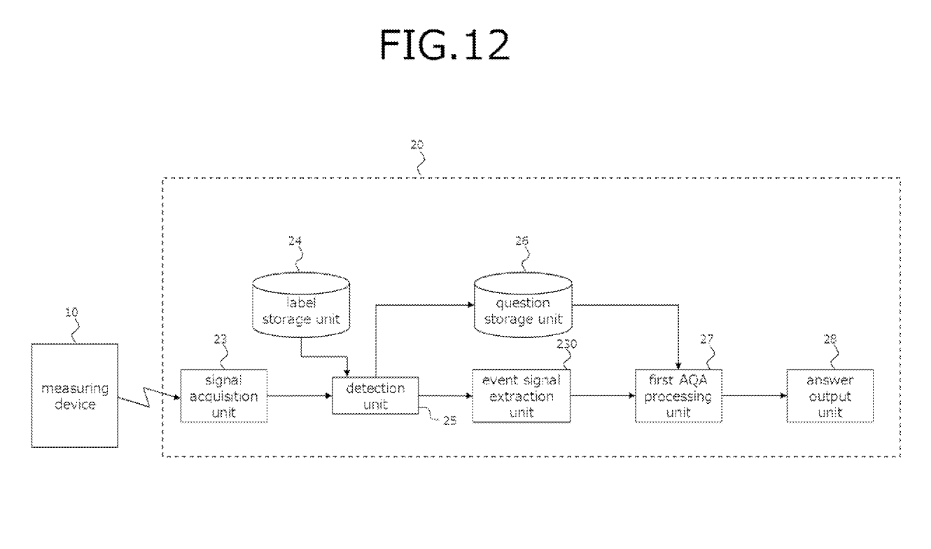

A third embodiment of the present invention will be described with reference to FIG. 12. The same reference numerals are given to the same configurations as those of the first and second embodiments and are used in the description of the present embodiment, and the description of the components that operate in the same manner as the operation in the above embodiment will be omitted.

FIG. 12 is a block diagram illustrating an example of a functional configuration of the signal processing device 20 according to the present embodiment. In the present embodiment, the signal processing device 20 includes an event signal extraction unit 230 in addition to the signal acquisition unit 23, the label storage unit 24, the detection unit 25, the question storage unit 26, the first AQA processing unit 27, and the answer output unit 28.

The detection unit 25 outputs the event label 30, all the time-series signals, and the interval information regarding the event interval to the event signal extraction unit 230.

The event signal extraction unit 230 receives the event label 30 and the interval information (for example, the start time and the end time) acquired from the detection unit 25, and reads and executes the program stored in the program storage unit 21, thereby extracting the corresponding event signal from the time-series signal based on the interval information. In the present embodiment, the extracted event signal is referred to as an extracted signal. Specifically, the event signal extraction unit 230 extracts the corresponding event signal from the time-series signal acquired by the signal acquisition unit 23 using interval information, for example, a start time and an end time, regarding the event interval corresponding to each event label 30 (for example, "train", "announcement sound", "train, impact sound", or the like). Although the signal is extracted using the time in this example, another appropriate algorithm may be used depending on the type of the interval information. By this extraction processing, only the event signal related to the event label 30 is extracted as an extracted signal. The event signal extraction unit 230 supplies the extracted signal to the first AQA processing unit 27 together with the event label 30. By supplying the extracted signal to the first AQA processing unit 27, the AQA processing for a desired event can be performed in a pinpoint manner.

In the present embodiment, the input of the first AQA processing unit 27 is the extracted signal, the corresponding event label 30, and the question sentence 31 or the question list selected in the question selection unit 220. The first AQA processing unit 27 generates an answer sentence 32 to the question sentence 31 based on these inputs. In the present embodiment, since the first AQA processing unit 27 processes only the extracted signal instead of the entire time-series signal, it is possible to avoid analysis of unnecessary audio, and by efficiently analyzing only the signal of a necessary interval, the amount of signal to be processed is reduced, and it is possible to reduce the load of the first AQA processing unit 27.

### Fourth Embodiment

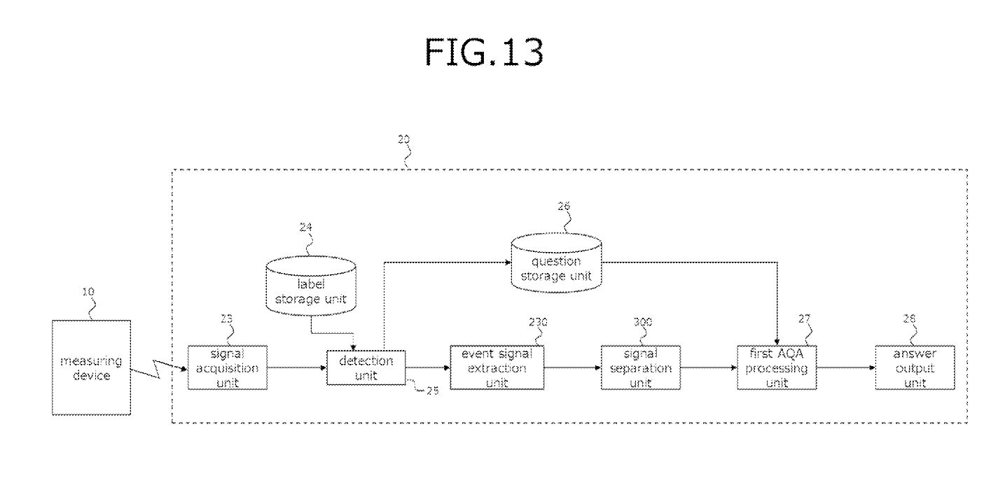

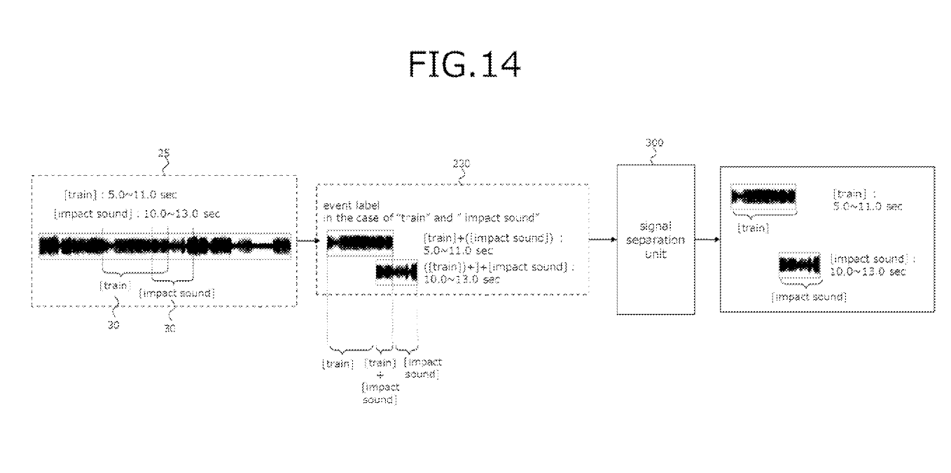

A fourth embodiment of the present invention will be described with reference to FIGS. 13 and 14. The same reference numerals are given to constituent elements that operate in the same manner as in the first to third embodiments, and description thereof will be omitted. The present embodiment is different from the third embodiment in that additional processing is performed on the extracted signal extracted by the event signal extraction unit 230. In the third embodiment, it is considered that the extracted signal and the event label 30 correspond to each other one to one, but in the fourth embodiment, a case where another event label 30 is included in the extracted signal is also treated.

FIG. 13 is a block diagram illustrating an example of a functional configuration of the signal processing device 20 according to the present embodiment. In the present embodiment, the signal processing device 20 includes a signal separation unit 300 in addition to the signal acquisition unit 23, the label storage unit 24, the detection unit 25, the question storage unit 26, the first AQA processing unit 27, the answer output unit 28, and the event signal extraction unit 230.

The signal separation unit 300 reads and executes the program stored in the program storage unit 21, thereby individually separating the signal component of each event from the extracted signal in which the plurality of event signals are superimposed, and acquiring only the signal component corresponding to the desired event label 30. Specifically, the event signal extraction unit 230 extracts a first event signal corresponding to a first event label from the time-series signal, extracts a second event signal corresponding to a second event label different from the first event label from the time-series signal, and when at least a part of the first event signal and the second event signal is superimposed, the signal separation unit 300 separates the first event signal and the second event signal. The separated signal is supplied to the first AQA processing unit 27.

FIG. 14 is a diagram illustrating an example of a processing configuration of the signal separation unit 300. Here, it is considered that at least the event labels "train" and "impact sound" are acquired by the label acquisition unit 201 included in the detection unit 25. The detection unit 25 detects the extracted signals for the event labels "train" and "impact sound" and the interval information of the extracted signals (for example, the start time and the end time of the event). At this time, since the "train" is an interval from 5.0 seconds to 11.0 seconds and the "impact sound" is an interval from 10.0 seconds to 13.0 seconds, the event signals of the "train" and the "impact sound" are superimposed in the interval from 10.0 seconds to 11.0 seconds.

The event signal extraction unit 230 extracts a signal corresponding to the event label 30. When the event label 30 is specified by separate event labels of "train" and "impact sound", the respective events are independent events, and thus the interval of the extracted signal changes. In the case of the event label "train", a signal in an interval from 5.0 seconds to 11.0 seconds is extracted as a extracted signal, and in the case of the event label "impact sound", a signal in an interval from 10.0 seconds to 13.0 seconds is extracted as a extracted signal. At this time, the extracted signal of the event label "train" is extracted including the signal of the event label "impact sound". Similarly, the extracted signal of the " impact sound" includes the signal of the event label "train" and is extracted. In this way, in a case where at least a part of the event signals corresponding to different events overlap, the signal of the event label 30 to be treated includes the signal of another event label 30. At this time, the signal separation unit 300 separates only the signal of the event label 30 to be treated.

The signal separation unit 300 has a function of individually separating signal components of respective events from a extracted signal on which a plurality of event signals are superimposed. A filtering technique using a deep neural network (DNN) is incorporated in the signal separation unit 300, and various algorithms for identifying a characteristic signal pattern of each event with high accuracy are applied.

First, a fast Fourier transform (FFT) is performed on an input signal to analyze the time-frequency domain characteristics of the signal. Based on this analysis, a characteristic frequency component of each event is specified, and filtering process for identifying signal components of other events from an event interval to be treated (for example, an event interval signal of "train" from 5.0 seconds to 11.0 seconds) is performed.

A machine learning model using a DNN is used for the filtering process, and this model is trained to recognize characteristic signal patterns of various events based on a data set learned in advance. Specifically, the DNN extracts features of the input signal in the time-frequency domain, and identifies a signal component related to an event to be treated and a signal component related to another event. Supervised learning using a large number of different patterns of superimposed signals is applied to this training, and a multilayer structure may be provided to improve accuracy. For example, by using a convolutional neural network (CNN), local features of signals can be effectively grasped, and signal separation in consideration of temporal dependency of signals can be performed by using a recurrent neural network (RNN). In addition, these DNN models take acoustic features such as Mel-frequency cepstral coefficients (MFCCs) as input.

Furthermore, in addition to the MFCC, acoustic features such as a chroma feature, a zero crossing rate, a spectral centroid, a spectral flux, a spectrogram image by short-time Fourier transform (STFT), a delta coefficient, and a delta-delta coefficient can also be used. These features contribute to improvement of classification performance by the DNN and effectively capture temporal and frequency variations of the signal.

In the signal separation unit of the present invention, various known methods can be used in addition to the DNN model shown in the above example. For example, instead of the DNN, it is conceivable to apply a technique such as a CNN, a long short term memory (LSTM), a non-parametric method, a blind source separation (BSS) algorithm, or independent component analysis (ICA). This allows for flexible adaptation to different types of event signals and environmental conditions.

The signal separation unit 300 effectively separates the extracted signal of the event label "train" and the signal component of the event label "impact sound", and acquires only the signal component of "train". Similarly, the signal component of the event label "train" is separated from the extracted signal of the event label "impact sound", and only the signal of the "impact sound" is acquired. The signal separated by the signal separation unit 300 is supplied to the first AQA processing unit 27.

In the present embodiment, the label acquisition unit 201 included in the detection unit 25 confirms whether or not the extracted signal corresponding to the input event label 30 overlaps with the extracted signal of another event label 30, and when the extracted signals overlap with each other, the signal separation unit 300 separates only the signal corresponding to the corresponding event label 30.

As described above, in the present embodiment, only the signal related to the desired event is separated from the event signal corresponding to the specific event label, and the AQA processing is performed on the separated signal, so that a more accurate answer sentence can be acquired.

### Fifth Embodiment

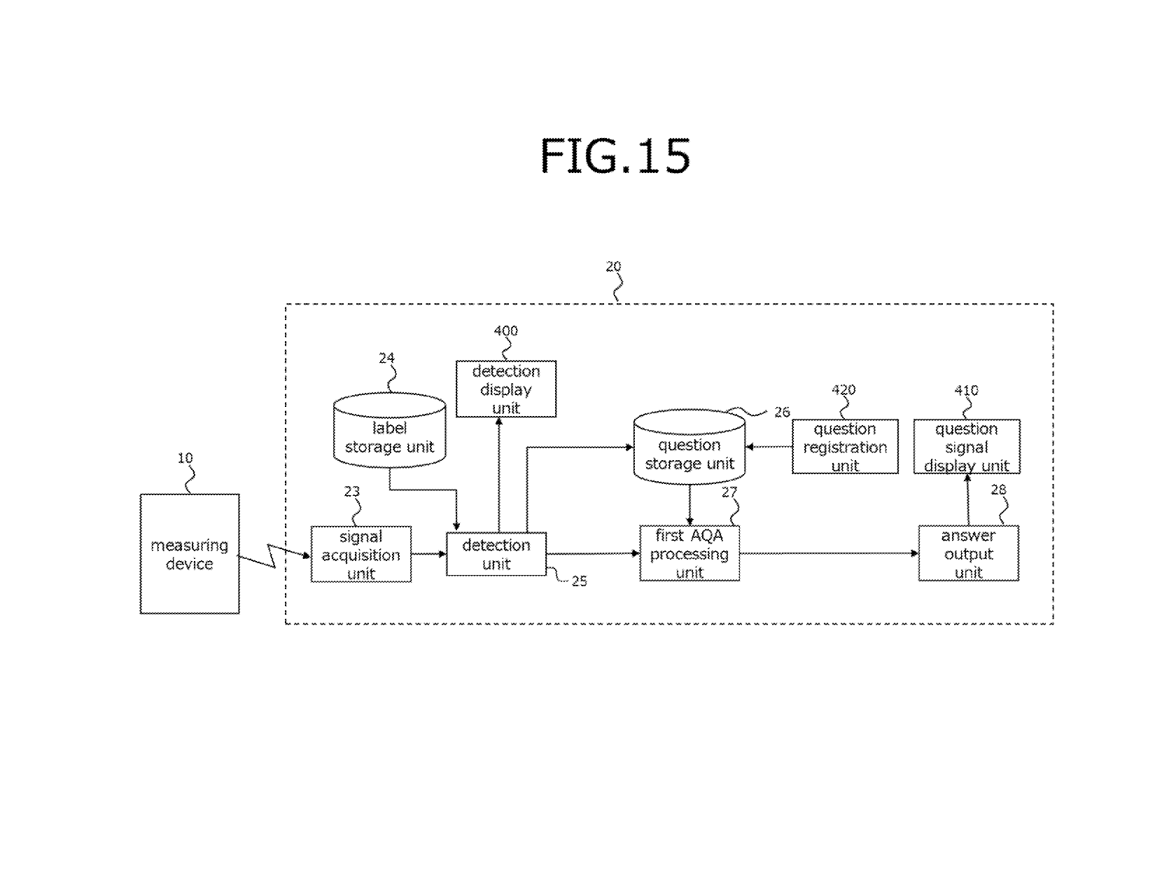

Next, a fifth embodiment will be described with reference to FIGS. 15 to 18. The same reference numerals are given to constituent elements that operate in the same manner as in the first to fourth embodiments, and description thereof will be omitted.

FIG. 15 is a block diagram illustrating an example of a functional configuration of the signal processing device 20 according to the present embodiment. In the present embodiment, the signal processing device 20 includes a detection display unit 400, a question signal display unit 410, and a question registration unit 420 in addition to the signal acquisition unit 23, the label storage unit 24, the detection unit 25, the question storage unit 26, the first AQA processing unit 27, and the answer output unit 28.

The detection display unit 400 displays, on the screen, the event label 30 corresponding to the event detected by the detection unit 25, the interval information (for example, the start time and the end time of the event), and the transfer state. Furthermore, the user can edit the question list and register a new event label 30 and a new question sentence 31 via the detection display unit 400.

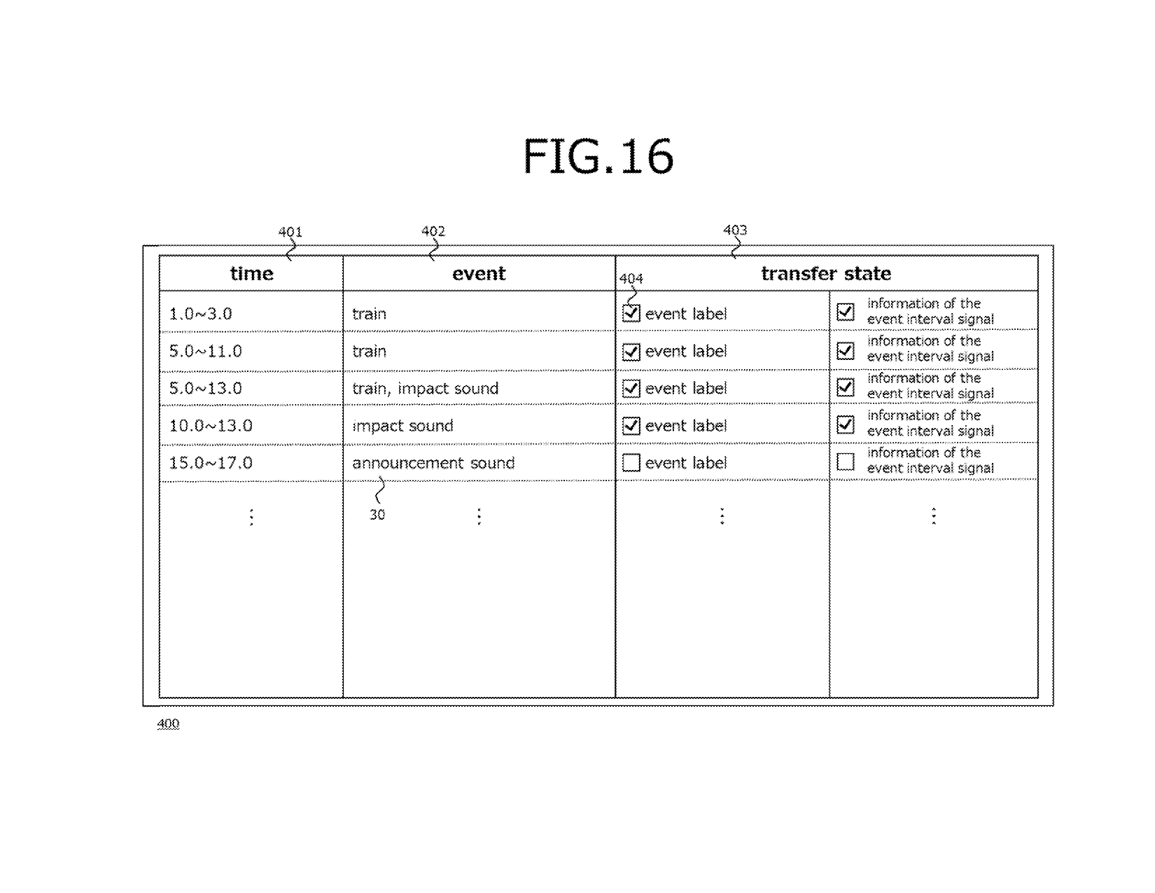

FIG. 16 is a schematic diagram illustrating the detection display unit 400. The detection display unit 400 includes a screen 401 for displaying interval information about the event interval detected by the detection unit 25, a screen 402 for displaying the event label 30, and a screen 403 for displaying a transfer state. In FIG. 16, the screen 401 is displayed by time, but the display may be changed according to the format of the interval information. The screen 403 shows a state of whether the event label 30 and the interval information are transferred to the next process, and the situation can be confirmed by a check box 404. If the check is set, it can be confirmed that the transfer is normally performed, and if the check is not set, it can be confirmed that the transfer has failed due to some problem. Although the check box 404 is used here, various display forms can be used without being limited to this. For example, various display forms such as a circle, a cross, a solid color, and a character may be used instead of the check box.

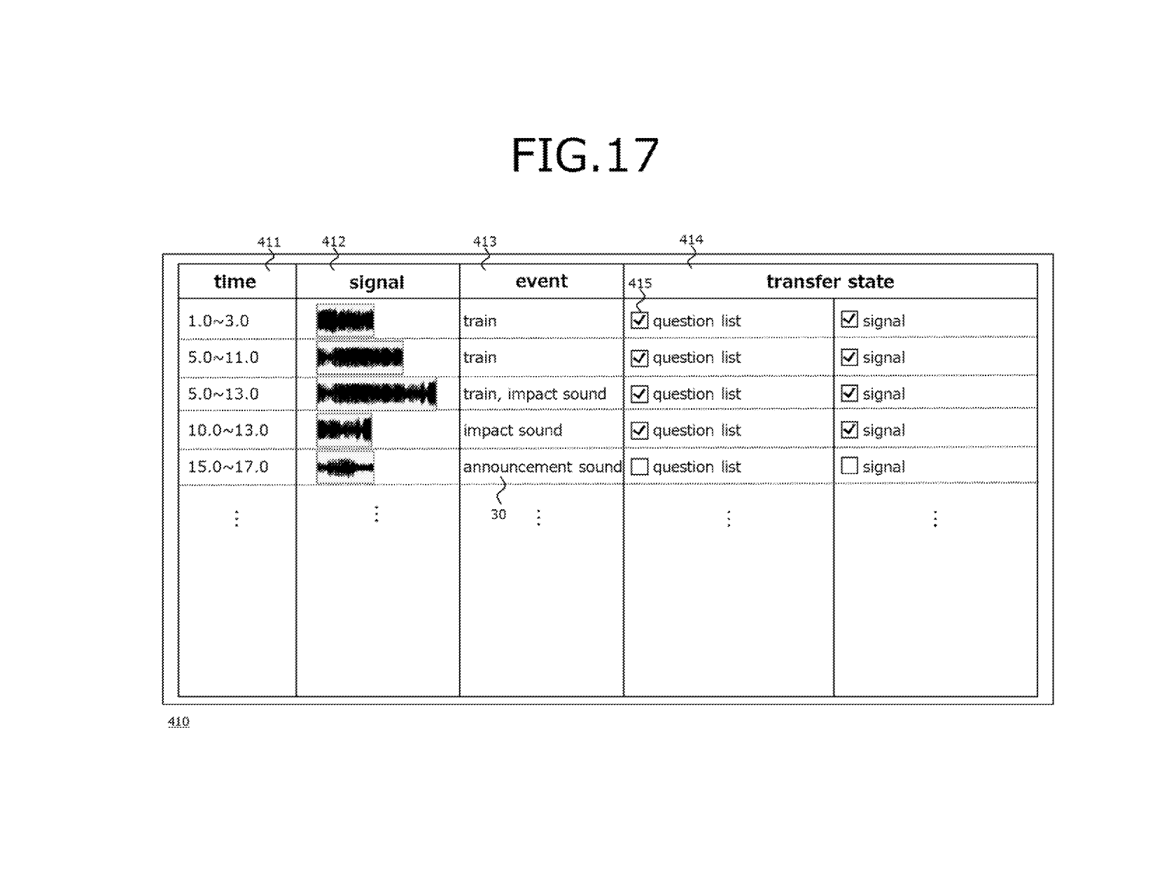

FIG. 17 is a schematic diagram illustrating the question signal display unit 410. The question signal display unit 410 is configured by a screen 411 for displaying interval information relating to an event interval, a screen 412 for displaying an event signal, a screen 413 for displaying an event label 30, and a screen 414 for displaying a question list and a state of whether or not the event signal is transferred to the first AQA processing unit 27. In FIG. 17, the screen 411 is displayed by time, but the display may be changed according to the format of the interval information regarding the event interval. A screen 414 shows a question list and a state of whether an event signal is transferred, and the situation can be checked by a check box 415. If the check is set, it can be confirmed that the transfer is normally performed, and if the check is not set, it can be confirmed that the transfer has failed due to some problem. Although the check box 415 is used here, various display forms can be used without being limited to this. For example, various display forms such as a circle, a cross, a solid color, and a character may be used instead of the check box.

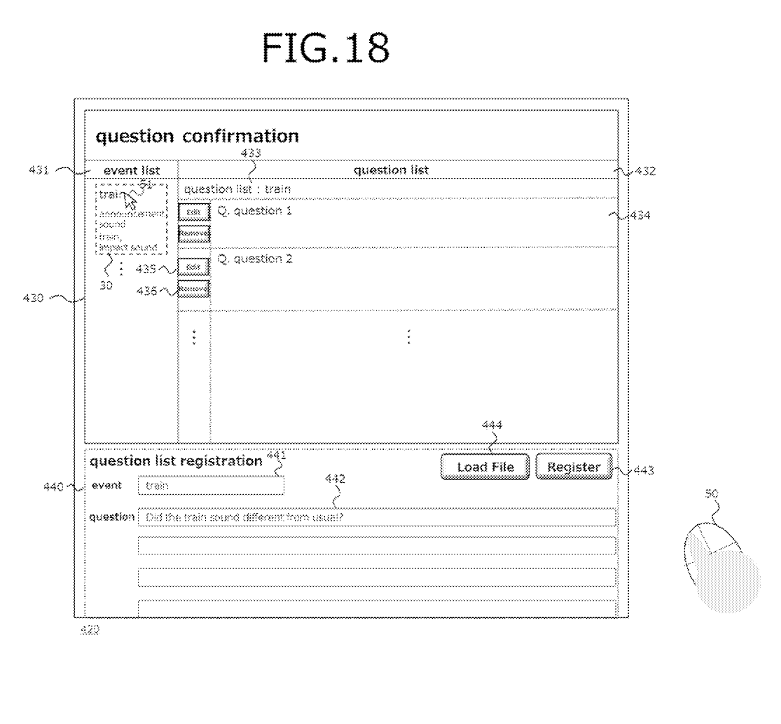

FIG. 18 is a schematic diagram illustrating the question registration unit 420. The question registration unit 420 is a screen for confirming the content of the question list already registered in the question storage unit 26, editing the question sentence 31 in the question list, and additionally registering a new question sentence 31. The question registration unit 420 includes a question confirmation screen 430 for displaying a question list registered in the question storage unit 26, and a question list registration screen 440 for collectively registering new question sentences 31 in the question list.

The question confirmation screen 430 includes an event list screen 431 for displaying a list of the event labels 30 and a question list screen 432 for displaying a question list.

By operating the mouse 50 to move the cursor 51 and select the event label 30 displayed on the event list screen 431, a question list of the selected event is displayed on the question list screen 432 in conjunction with the selection. The question list screen 432 includes an event display 433 for displaying a selected event, a question sentence 434 in the question list, an edit button 435 for editing the question sentence, and a delete button 436 for deleting the question sentence. In the example of FIG. 18, the event "train" is selected on the event list screen 431, and thus the question list of "train" is displayed on the question list screen 432 for displaying the question list. Here, the characters of the events on the event list screen 431 are selected, but the selection is not limited to this, and various selection forms can be used. For example, various selection forms such as a check box, a circle, a cross, a solid, and a radio button may be used.

The question list registration screen 440 includes an event input box 441 for inputting the event label 30 to be registered, a question input box 442 for inputting the question sentence 31, a registration button 443 for registering information input in the event input box 441 and the question input box 442 in the question list, and a file read button 444 for reading an external file and collectively registering the question sentence. The user inputs the event label 30 of an event to be registered in the event input box 441, and inputs the question sentence 31 corresponding to the event label 30 in the question input box 442. At this time, a plurality of question sentences 31 can be input simultaneously. After the input to the question input box 442 is completed, the information is registered in the question list by selecting a registration button 443. Further, instead of manually inputting the event label 30 and the question sentence 31 into the question input box 442, the event label 30 and the question sentence 31 may be written in an arbitrary external file and read by the file read button 444, thereby automatically registering the event label 30 and the question sentence 31 in a batch. The file at this time may be in various file formats such as a csv file and a tsv file.

### Sixth Embodiment

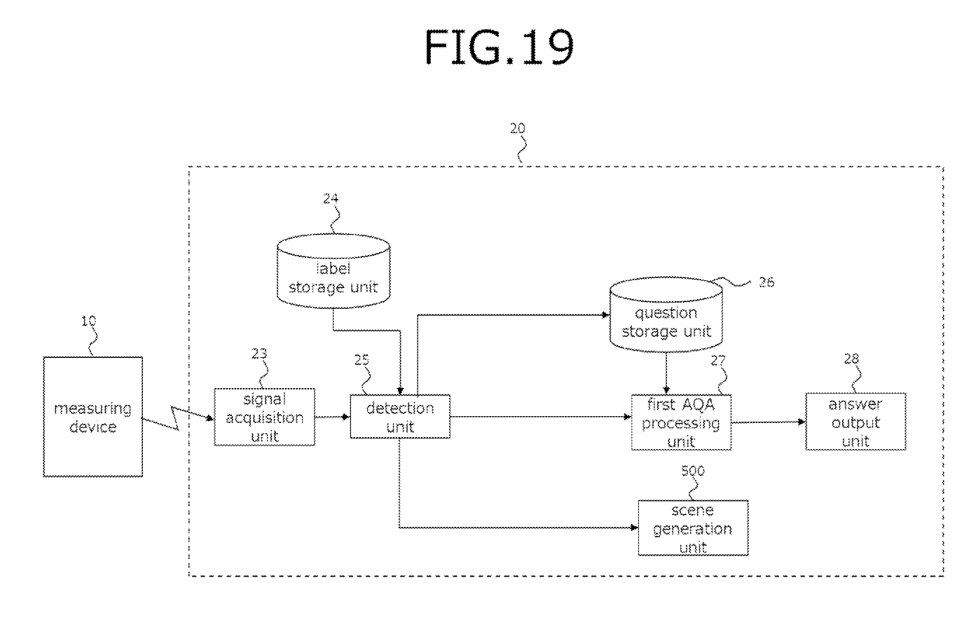

Next, a sixth embodiment will be described with reference to FIGS. 19 to 23. The same reference numerals are given to constituent elements that operate in the same manner as in the first to fifth embodiments, and description thereof will be omitted.

In the sixth embodiment, processing of generating an image / video using an event signal is additionally performed.

FIG. 19 is a block diagram illustrating an example of a functional configuration of the signal processing device 20 according to the present embodiment. In the present embodiment, the signal processing device 20 includes a scene generation unit 500 in addition to the signal acquisition unit 23, the label storage unit 24, the detection unit 25, the question storage unit 26, the first AQA processing unit 27, and the answer output unit 28.

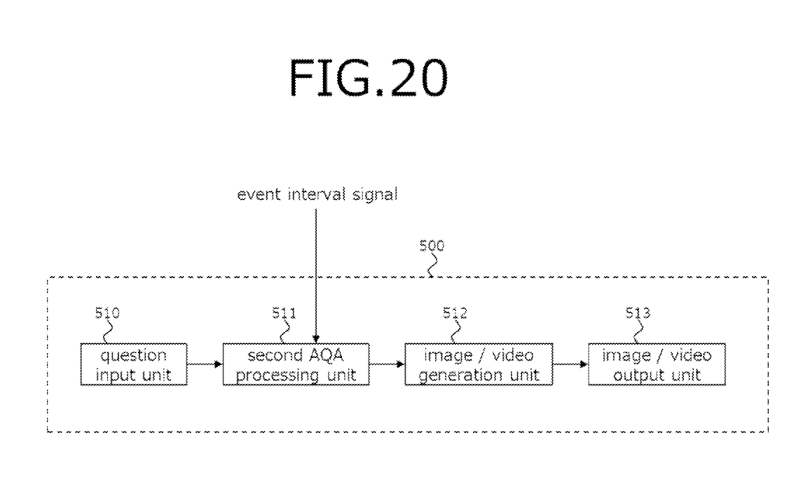

FIG. 20 is a block diagram illustrating an example of a functional configuration of the scene generation unit 500. The scene generation unit 500 includes a question input unit 510, a second AQA processing unit 511, an image / video generation unit 512, and an image / video output unit 513. The scene generation unit 500 reads and executes the program stored in the program storage unit 21, thereby generating a situation description sentence which is a description acquired by verbalizing the situation of the event on the basis of the event signal, and generating a description image which is an image or a video showing the situation of the event on the basis of the situation description sentence.

The question input unit 510 is an interface having a function of inputting a question sentence for explaining what kind of situation the event that has actually occurred is in, to the second AQA processing unit 511. Here, the question sentence for explaining the situation is referred to as a situation generation question sentence. The question input unit 510 receives an input of a prompt instructing to verbalize the situation of the event estimated from the event signal.

The second AQA processing unit 511 receives the event signal and the above-described prompt as inputs and outputs a situation description sentence. The second AQA processing unit 511 has the same processing configuration as the first AQA processing unit 27 and receives the situation generation question sentence supplied from the question input unit 510 and the time-series signal, and outputs an answer sentence explaining what situation the event signal included in the time-series signal is. Here, the answer sentence is referred to as a situation description sentence.

The image / video generation unit 512 receives the situation description sentence supplied from the second AQA processing unit 511 as an input, and generates an image or a video according to the input situation description sentence using a generation AI technique of a deep learning model such as a generation inverse network (GAN), an extended GAN (BigGAN), or diffusion models. The generated image or video data is sent to the image / video output unit 513 and output.

The image / video output unit 513 outputs and displays at least one of the situation generation question sentence, the answer sentence generated by the second AQA processing unit 511, the time-series signal acquired by the signal acquisition unit 23, the event label 30 detected by the detection unit 25 and the event signal corresponding thereto, and the explanatory image.

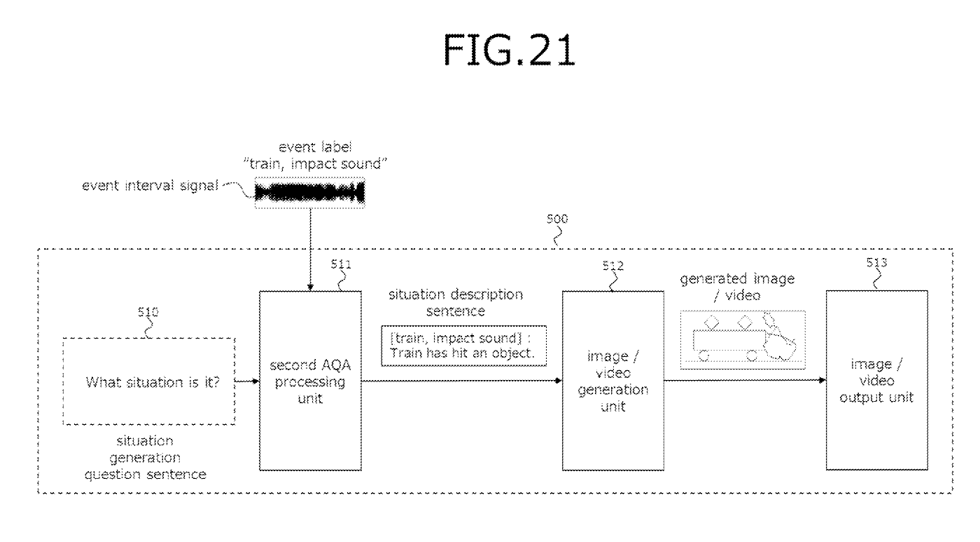

FIG. 21 is a diagram illustrating an example of a processing procedure of the scene generation unit 500. First, a situation generation question sentence is input in the question input unit 510. In the question input unit 510, a question of a sentence that explains a situation for an event signal, such as "What situation is it?" or "What scene is it?", is input as a situation generation question sentence. The above-described prompt is an example, and a question sentence can be generated using another prompt. For example, different types of prompts or prompts with additional contextual information may be used to increase the accuracy and diversity of question generation. In addition, other languages such as English, Chinese, and Korean may be used. In the example of FIG. 21, the number of situation generation question sentences is one, but may be two or more. By generating two or more situation description sentences, the image / video generation unit 512 can generate an image or a video based on the plurality of situation description sentences. Therefore, it is possible to more specifically generate a scene, and it is possible to expect that a situation or a scene with high quality is generated. The second AQA processing unit 511 receives the event signal and the situation generation question sentence as inputs and generates a situation description sentence. Here, the event signal of the event label "train, impact sound" and the situation generation question sentence "What situation is it?" are input to the second AQA processing unit 511, and the second AQA processing unit 511 generates the situation description sentence "Train has hit an object.” Next, the image / video generation unit 512 generates an image or video based on the situation description sentence "The train has hit an object.” Finally, the generated image or video is output by the image / video output unit 513.

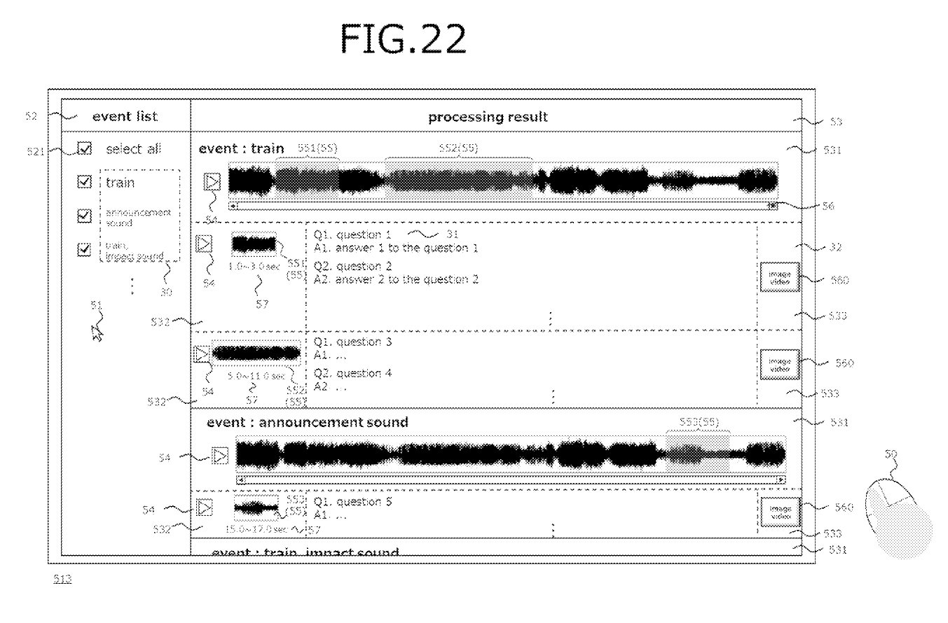

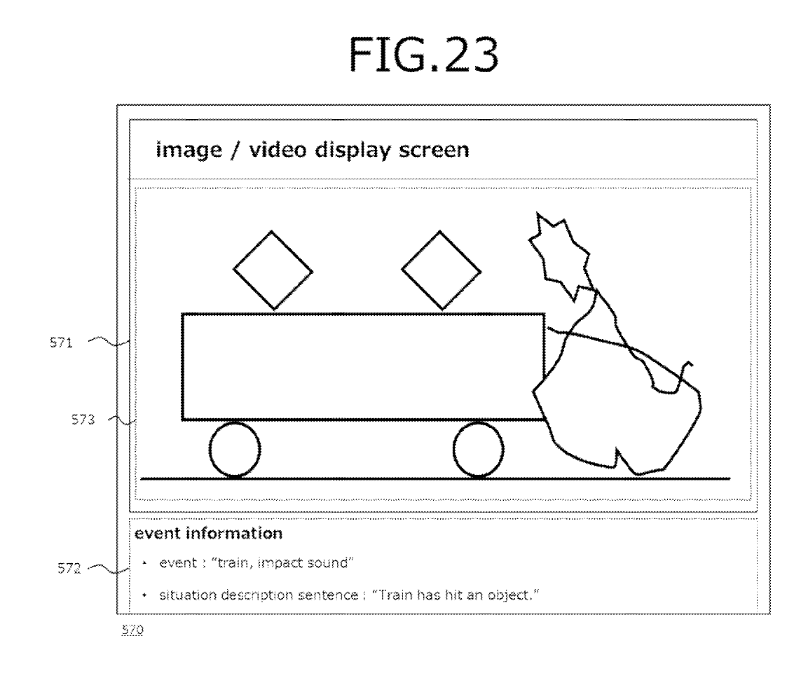

The image / video output unit 513 will be described with reference to FIGS. 22 and 23. The image / video output unit 513 shares the basic configuration with that in FIG. 7, and the operation is also the same as that in FIGS. 8 and 9.

FIG. 22 is a schematic diagram illustrating an example of an output screen of the image / video output unit 513. The image / video output unit 513 includes an image / video button 560 in addition to the answer output unit 28 illustrated in FIG. 9. By operating the mouse 50 to move the cursor 51 and selecting the image / video button 560, the screen can be moved to the image / video display screen 570. The image / video button 560 is provided for each event signal.

FIG. 23 is a schematic diagram illustrating an image / video display screen 570 that appears after the image / video button 560 is selected. The image / video display screen 570 includes an image / video screen 571 and an event information screen 572. The generated image / video 573 generated by the image / video generation unit 512 is displayed on the image / video screen 571. The event information screen 572 displays an event label corresponding to the event signal selected by the image / video button 560 and also displays a situation description sentence generated by the second AQA processing unit 511.

### Seventh Embodiment

In the first to sixth embodiments, the signal is treated as the audio data, but in the seventh embodiment, a case where the time-series signal processed by the signal processing device 20 is a heart rate will be described as an example. Note that detailed algorithms are the same as those in the first to sixth embodiments, and a description thereof will be omitted. In addition, the same reference numerals are given to constituent elements that operate in the same manner, and description thereof will be omitted.

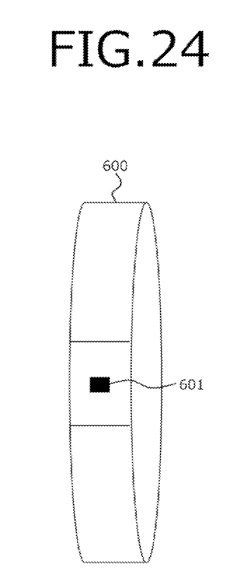

FIG. 24 is an example of an external appearance of a wearable device 600 according to the present embodiment. As illustrated in FIG. 24, the wearable device 600 includes a heart rate sensor 601.

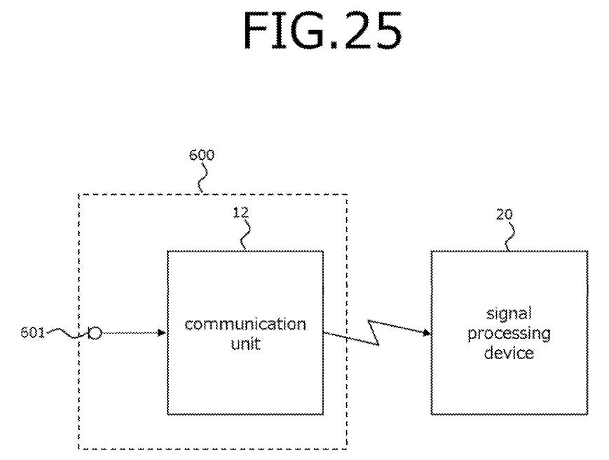

FIG. 25 is a block diagram illustrating a configuration example of a wearable device 600 according to the seventh embodiment. The wearable device 600 includes a heart rate sensor 601 and a communication unit 12.

The heart rate sensor 601 monitors the heart rate and converts it into an analog signal. The analog signal is input to the communication unit 12 via a wired or wireless connection.

The communication unit 12 converts the analog signal into a digital signal and transmits the digital signal to the signal processing device 20 in a wired or wireless manner. The signal processing device 20 receives the time-series signal transmitted from the communication unit 12 and performs a predetermined operation.

In the seventh embodiment, a user wears the wearable device 600 and measures a heart rate signal with the heart rate sensor 601, and a utilization scene in which the user analyzes his / her own behavior or emotion based on the heart rate signal will be described as an example.

First, the user may input the event label 30 to be detected from the heart rate signal through a predetermined interface. The interface used for input may be the detection display unit 400, or may be a device such as a computer or a smartphone connected to the signal processing device 20 via a wired or wireless network. The registered event label 30 is stored in the label storage unit 24. In the present embodiment, it is considered that the user inputs the event labels 30 of "stress", "relaxation", and "exercise, stress".

The signal processing device 20 receives the heart rate signal as an input, and detects a signal corresponding to the event label 30 of "stress", "relaxation", and "exercise, stress" registered by the user by the event detection unit 202. For this detection, for example, analysis of heart rate variability (HRV) or a time-frequency analysis method is used. Based on the characteristics of the detected heart rate signal, it is determined whether the heart rate signal is determined as "stress", "relaxation", or "exercise, stress".

The interval information regarding the event interval is sent to the detection information output unit 203, and the heart rate signal, the event label 30, and the interval information (for example, the start time and the end time) of the event interval are supplied from the detection information output unit 203 to the first AQA processing unit 27.

In the question storage unit 26, a corresponding question list is selected based on the detected event label 30. For example, when "stress" is detected, a question list in which a question sentence 31 related to a cause or a situation of the stress is described is selected.

The first AQA processing unit 27 receives the heart rate signal, the interval information, the event label 30, and the question list, generates the answer sentence 32 using them as an input, and displays the result on the answer output unit 28. For example, in response to the event label indicating “stress”, an extracted signal corresponding to the event label and a question sentence 31 "How stressed are you feeling?" are provided, whereby an answer sentence 32, "Due to the rapid increase in heart rate, it can be inferred that strong stress is present," is generated. Similarly, in response to the event label indicating "relax", the answer sentence 32 corresponding to "relax" is generated.

### Eighth Embodiment

In the first to sixth embodiments, the signal is treated as audio data, but in the eighth embodiment, a case where the time-series signal processed by the signal processing device 20 is a signal obtained from an acceleration sensor will be described as an example. Note that detailed algorithms are the same as those in the first to sixth embodiments, and a description thereof will be omitted. In addition, the same reference numerals are given to constituent elements that operate in the same manner, and description thereof will be omitted.

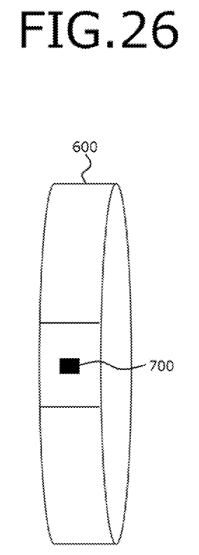

FIG. 26 is an example of an external appearance of a wearable device 600 according to the present embodiment. The wearable device 600 includes an acceleration sensor 700.

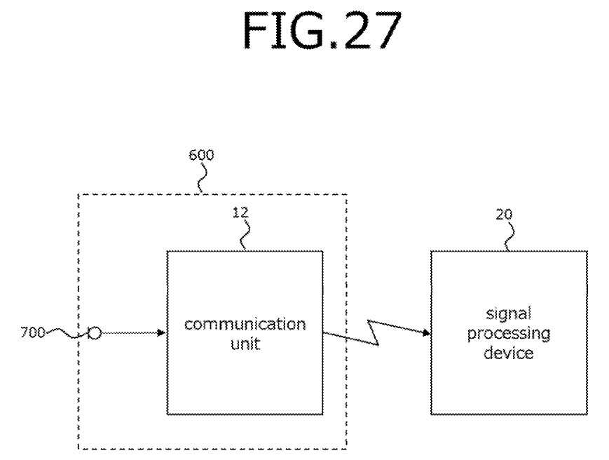

FIG. 27 is a block diagram illustrating a configuration example of a wearable device 600 according to the eighth embodiment. As illustrated in FIG. 26, the wearable device 600 includes an acceleration sensor 700 and the communication unit 12.

The acceleration sensor 700 monitors an acceleration signal and converts the acceleration signal into an analog signal. The analog signal is input to the communication unit 12 via a wired or wireless connection.

The communication unit 12 converts an analog signal into a digital signal and transmits the digital signal to the signal processing device 20 in a wired or wireless manner. The signal processing device 20 receives the time-series signal transmitted from the communication unit 12 and performs a predetermined operation.

In the eighth embodiment, a user wears the wearable device 600 and measures an acceleration signal by the acceleration sensor 700, and a utilization scene in which the user analyzes his / her own behavior based on the acceleration signal will be described as an example.

First, the user may input the event label 30 to be detected from the heart rate signal through a predetermined interface. The interface used for input may be the detection display unit 400 or may be a device such as a computer or a smartphone connected to the signal processing device 20 via a wired or wireless network. In this embodiment, it is considered that the user inputs the event labels 30 of "run", "fall", and "climb stairs, run".

The signal processing device 20 receives the acceleration signal as an input and detects a signal corresponding to the event label 30 of "run", "fall", and "climb stairs, run" registered by the user by the event detection unit 202. For this detection, pattern recognition of the acceleration signal or a machine learning algorithm is used. Based on the characteristics of the detected acceleration signal, it is determined whether to determine "run", "fall", or "climb stairs, run".

The interval information regarding the event interval is sent to the detection information output unit 203, and the signal acquired from the acceleration sensor, the event label 30, and the interval information of the event interval (for example, the start time and the end time) are supplied from the detection information output unit 203 to the first AQA processing unit 27.

In the question storage unit 26, a corresponding question list is selected based on the detected event label 30. For example, when "run" is detected, a question list in which a question sentence 31 related to a speed when running is described is selected.

The event signal extraction unit 230 extracts a signal using interval information (for example, a start time and an end time) regarding an event interval for each event label 30. For example, if the event label is "run", a signal corresponding to "run" is extracted, and if the event label is "fall", a signal corresponding to "fall" is extracted.

The first AQA processing unit 27 receives the question list corresponding to the event label 30 and the extracted signal, generates an answer sentence 32 using the question list and the extracted signal as inputs, and displays a result on the answer output unit 28. For example, in response to the event label indicating “run”, an extracted signal corresponding to the event label and a question sentence 31 "How fast does he[she] run?" are provided, whereby an answer sentence 32, "He[She] is supposed to run at about 8 km/h." is generated. Similarly, in response to the event label indicating "fall down", the answer sentence 32 corresponding to "fall down" is generated, and in response to the event label indicating "climb stairs, run", the answer sentence 32 corresponding to "climb stairs, run" is generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are included in the invention described in the claims and the equivalent scope thereof.

Hereinafter, the invention of the embodiment will be described below.

<1> A signal processing device comprising:
a signal acquisition unit configured to acquire a time-series signal,
a detection unit configured to detect a signal of an interval including an event indicated by an event label as an event signal from the time-series signal,
a first AQA processing unit configured to generate an answer sentence to a question sentence related to the event label, based on the time-series signal, interval information indicating a relationship between the time-series signal and the event signal, the event label.

<2> The signal processing device according to <1>, further comprising:
a label storage unit configured to store the event label, and
a question storage unit configured to store the question sentence related to the event label.

<3> The signal processing device according to <1> or <2>,
wherein the detection unit includes
a label acquisition unit configured to acquire the event label corresponding to an event to be detected from the time-series signal, and
an event detection unit configured to determine whether the event signal is included in the time-series signal using a machine learning model, and detect the event signal when it is determined that the event signal is included, and
a detection information output unit that outputs the time-series signal, the interval information, and the event label to the first AQA processing unit.

<4> The signal processing device according to <2>, further comprising:
a question selection unit configured to select a question sentence related to an event label corresponding to the event from the question storage unit storing a plurality of question sentences.

<5> The signal processing device according to any one of <1> to <4>, further comprising:
a question generation unit configured to generate a question sentence based on the event label.

<6> The signal processing device according to any one of <1> to <5>, further comprising:
an event signal extraction unit configured to extract the event signal as a extracted signal from the time-series signal on the basis of the interval information, wherein
the first AQA processing unit generates an answer sentence to the question sentence based on the extracted signal, the label, and the question sentence.

<7> The signal processing device according to <6>, further comprising:
a signal separation unit configured to separate a first event signal and a second event signal when at least a part of the first event signal and the second event signal is superimposed, wherein
the event signal extraction unit extracts the first event signal corresponding to the first event label from the time-series signal, and extracts a second event signal corresponding to a second event label different from the first event label from the time-series signal.

<8> The signal processing device according to any one of <1> to <7>, further comprising at least one of the following:
a detection display unit that displays the interval information and the event label,
an inquiry signal display unit configured to display the interval information, the event signal, and the event label, and
a question registration unit configured to display a registration screen for registering a question sentence to be additionally registered in the question storage unit.

<9> The signal processing device according to any one of <1> to <8>, further comprising:
a scene generation unit configured to generate a situation description sentence which is a description acquired by verbalizing a situation of the event on the basis of the event signal and generate a description image which is an image or a video showing the situation of the event on the basis of the situation description sentence.

<10> The signal processing device according to <9>, wherein the scene generation unit includes:
a question input unit that receives an input of a prompt instructing to verbalize a situation of the event estimated from the event signal,
a second AQA processing unit that receives the event signal and the prompt as inputs and outputs the situation description sentence,
an image / video generation unit that generates the explanatory image based on the situation description sentence, and
an image / video output unit that outputs at least one of the situation description sentence or the description image.

<11> The signal processing device according to any one of <1> to <10>, further comprising:
an answer output unit configured to output the answer sentence and display the question sentence, the answer sentence to the question sentence, and the event label corresponding to the event on a screen.

<12> A signal processing method comprising:
acquiring a time-series signal by a signal acquisition unit,
detecting, by a detection unit, a signal of an interval including an event indicated by an event label as an event signal from the time-series signal,
generating, by a first AQA processing unit, an answer sentence to a question sentence based on the time-series signal, interval information indicating a relationship between the time-series signal and the event signal, the event label, and the question sentence related to the event label.

<13> A non-transitory computer-readable storage medium storing a program that causes a processor to execute,
causing a signal acquisition unit to acquire a time-series signal,
causing a detection unit to detect a signal of an interval including an event indicated by an event label as an event signal from the time-series signal,
causing a first AQA processing unit to generate an answer sentence to a question sentence on the basis of the time-series signal, interval information indicating a relationship between the time-series signal and the event signal, the event label, and the question sentence related to the event label.

What is claimed is:

1. A signal processing device comprising:
a signal acquisition unit configured to acquire a time-series signal,
a detection unit configured to detect a signal of an interval including an event indicated by an event label as an event signal from the time-series signal,
a first AQA processing unit configured to generate an answer sentence to a question sentence related to the event label, based on the time-series signal, interval information indicating a relationship between the time-series signal and the event signal, the event label.

2. The signal processing device according to claim 1, further comprising:
a label storage unit configured to store the event label, and
a question storage unit configured to store the question sentence related to the event label.

3. The signal processing device according to claim 1, wherein
the detection unit includes
a label acquisition unit configured to acquire the event label corresponding to an event to be detected from the time-series signal, and
an event detection unit configured to determine whether the event signal is included in the time-series signal using a machine learning model, and detect the event signal when it is determined that the event signal is included, and
a detection information output unit that outputs the time-series signal, the interval information, and the event label to the first AQA processing unit.

4. The signal processing device according to claim 2, further comprising:
a question selection unit configured to select a question sentence related to an event label corresponding to the event from the question storage unit storing a plurality of question sentences.

5. The signal processing device according to claim 1, further comprising:
a question generation unit configured to generate a question sentence based on the event label.

6. The signal processing device according to claim 1, further comprising:
an event signal extraction unit configured to extract the event signal as a extracted signal from the time-series signal on the basis of the interval information, wherein
the first AQA processing unit generates an answer sentence to the question sentence based on the extracted signal, the label, and the question sentence.

7. The signal processing device according to claim 6, further comprising:
a signal separation unit configured to separate a first event signal and a second event signal when at least a part of the first event signal and the second event signal is superimposed, wherein
the event signal extraction unit extracts the first event signal corresponding to the first event label from the time-series signal, and extracts a second event signal corresponding to a second event label different from the first event label from the time-series signal.

8. The signal processing device according to claim 1, further comprising at least one of the following:
a detection display unit that displays the interval information and the event label,
an inquiry signal display unit configured to display the interval information, the event signal, and the event label, and
a question registration unit configured to display a registration screen for registering a question sentence to be additionally registered in the question storage unit.

9. The signal processing device according to claim 1, further comprising:
a scene generation unit configured to generate a situation description sentence which is a description acquired by verbalizing a situation of the event on the basis of the event signal and generate a description image which is an image or a video showing the situation of the event on the basis of the situation description sentence.

10. The signal processing device according to claim 9, wherein the scene generation unit includes:
a question input unit that receives an input of a prompt instructing to verbalize a situation of the event estimated from the event signal,
a second AQA processing unit that receives the event signal and the prompt as inputs and outputs the situation description sentence,
an image / video generation unit that generates the explanatory image based on the situation description sentence, and
an image / video output unit that outputs at least one of the situation description sentence or the description image.

11. The signal processing device according to claim 1, further comprising:
an answer output unit configured to output the answer sentence and display the question sentence, the answer sentence to the question sentence, and the event label corresponding to the event on a screen.

12. A signal processing method comprising:
acquiring a time-series signal by a signal acquisition unit,
detecting, by a detection unit, a signal of an interval including an event indicated by an event label as an event signal from the time-series signal,
generating, by a first AQA processing unit, an answer sentence to a question sentence based on the time-series signal, interval information indicating a relationship between the time-series signal and the event signal, the event label, and the question sentence related to the event label.

13. A non-transitory computer-readable storage medium storing a program that causes a processor to execute,
causing a signal acquisition unit to acquire a time-series signal,
causing a detection unit to detect a signal of an interval including an event indicated by an event label as an event signal from the time-series signal,
causing a first AQA processing unit to generate an answer sentence to a question sentence on the basis of the time-series signal, interval information indicating a relationship between the time-series signal and the event signal, the event label, and the question sentence related to the event label.
